(19) United States
(12) Patent Application Publication
(10) Pub. No.: US 2021/0315768 A1
(43) Pub. Date: Oct. 14, 2021

(54) CRANIAL STIMULATION DEVICE

(71) Applicant: Salvatore MORRA, PIETRASANTA (Lucca) (IT)

(72) Inventor: Salvatore MORRA, PIETRASANTA (Lucca) (IT)

(21) Appl. No.: 17/267,548

(22) PCT Filed: Jul. 18, 2019
(86) PCT No.: PCT/IB2019/056155

§ 371 Date: Feb. 10, 2021

(30) Foreign Application Priority Data
Aug. 13, 2018 (IT) 202018000003256

(51) Int. Cl. A61H 7/00

(52) U.S. Cl. CPC A61H 7/006; A61H 2205/021; A61H 2201/1607; A61H 2201/1215

(57) ABSTRACT

A cranial stimulation device is provided, including a helmet suitable for wrapping at least a portion of the user's head and defining an inner surface facing the head; a massage band extending along the perimeter of the active surface; a massage block fastened to the helmet at the active surface; and a control unit suitable for controlling the motion of the massage band and of the massage block by varying their reciprocal distance.

The present invention relates to a cranial stimulation device of the type specified in the preamble of the first claim.

As is known, most cells in a person's central nervous system (CNS) obtain at least some of their nutrients through the cerebrospinal fluid (CSF). In fact, there is a membrane inside the skull of a person called the dura mater that adheres to the bone. The cerebrospinal fluid is found between the dura mater and the next membrane.

For the sake of precision, in the skull, there are a total of three membrane layers between the bones of the skull and the brain.

The cerebrospinal fluid lubricates these membranes and—by means of a process called diffusion—transports nutrients to the brain's nervous tissue.

If the cerebrospinal fluid circulation is interrupted or otherwise impaired, people may experience various symptoms such as fatigue, lack of mental concentration, lack of energy, and hair loss.

In recent years, it has been noted that increasingly sedentary lifestyles that are associated with contemporary urban life can have a negative effect on normal cerebrospinal fluid circulation. Therefore, since more and more occupations involve spending several hours sitting, for example, in front of computer screens, this problem is becoming more and more widespread.

In this context, the technical task underlying the present invention is to devise a cranial stimulation device that is capable of substantially avoiding at least some of the above-mentioned drawbacks.

An important purpose of the invention, within the scope of said technical task, is that of obtaining a cranial stimulation device capable of improving cerebrospinal fluid circulation and thus of solving, or at least of alleviating, problems such as fatigue, lack of mental concentration, lack of energy and hair loss.

The technical task and the specified purposes are achieved by devising a cranial stimulation device as claimed in attached claim 1. Exemplary preferred embodiments are described in the dependent claims.

The features and advantages of the invention will be clarified in the following detailed description of preferred embodiments of the invention, with reference to the accompanying drawings, in which:

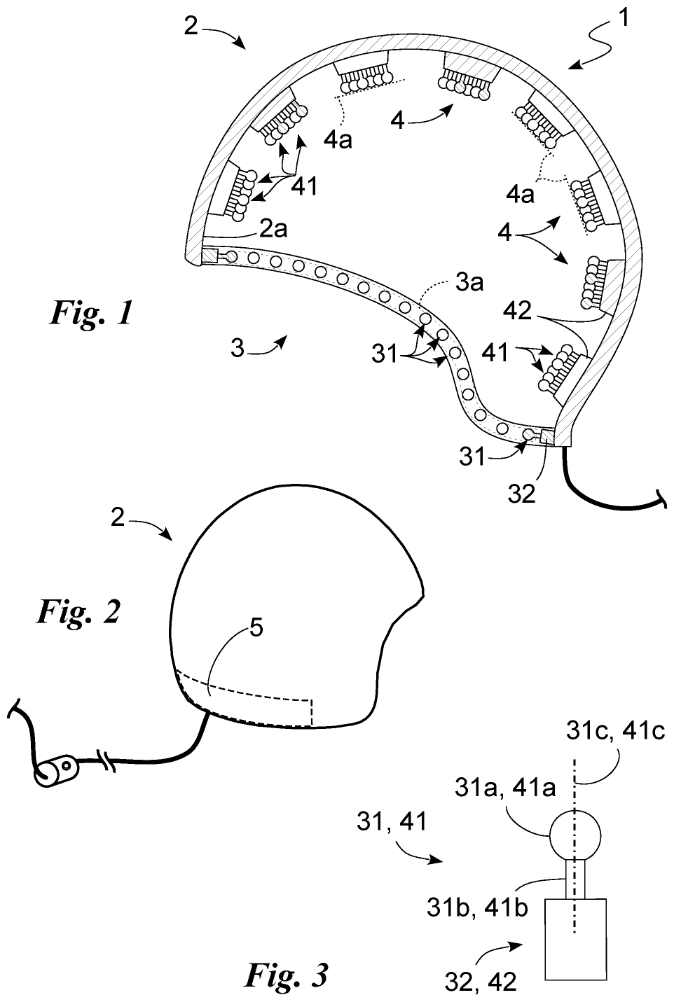

FIG. 1 shows a section of the cranial stimulation device according to the invention;

FIG. 2 illustrates a second view of the cranial stimulation device; and

FIG. 3 has a detail of the cranial stimulation device.

Herein, the measurements, values, shapes and geometric references (such as perpendicularity and parallelism), when used with words like “about” or other similar terms such as “approximately” or “substantially”, are to be understood as except for measurement errors or inaccuracies due to production and/or manufacturing errors and, above all, except for a slight divergence from the value, measurement, shape or geometric reference with which it is associated. For example, these terms, if associated with a value, preferably indicate a divergence of not more than 10% from said value.

Furthermore, when used, terms such as “first”, “second”, “higher”, “lower”, “main” and “secondary” do not necessarily identify an order, a priority relationship or a relative position, but can simply be used to distinguish more clearly the different components from each other.

Unless otherwise indicated, the measurements and data provided in this document are to be considered using International Standard Atmosphere ICAO (ISO 2533). Unless otherwise specified, as is clear from the following discussions, terms such as “processing”, “computing”, “determination”, “calculation”, or similar, are to be understood as referring to the action and/or processes of a computer, or similar electronic computing device, that manipulates and/or transforms data represented as physical, such as electronic quantities inside a computer system's registers and/or memories, into other data similarly represented as physical quantities within computer systems, registers or other information storage, transmission or display devices.

With reference to the Figures, the cranial stimulation device according to the invention is indicated as a whole by the number 1.

The cranial stimulation device 1 comprises a helmet 2 suitable for placing on the head of a user.

The helmet 2 is thus suitable for wrapping at least one portion of the user's head and defining an inner surface 2a facing said head and therefore the scalp.

The inner surface 2a is substantially counter-shaped to at least part of the head and in particular to the scalp.

It is suitable for placing near the scalp but not in contact with it.

The cranial stimulation device 1 comprises a massage band 3 extending along the perimeter of the helmet 2 and, more specifically, of the inner surface 2a.

The massage band 3 comprises one or more massage heads 31 defining a massage area 3a perimetric to the helmet 2; and a handler 32 of said heads 31.

Each head 31 defines a contact surface (in direct or indirect contact, e.g. through the hair) with the scalp, said surface being preferably spherical. It may be of a known type. A massage head 31 (FIG. 3) may comprise a contact portion 31a and a support portion 31b located between the contact portion 31a and the handler 32.

The support portion 31b may define a longitudinal axis 31c suitable for placing in use, i.e. when the device 1 and therefore the helmet 2 are being worn, substantially perpendicular to the scalp. During operation, it may be used to rotate the contact portion 31a around said longitudinal axis 31c.

The handler 32 is suitable for fastening the heads 31 to the helmet 2.

It is electric.

The handler 32 is suitable for moving the massage heads 31, making them complete a suitably circular trajectory. More specifically, it is suitable for moving the massage heads 31 synchronously and/or reciprocally.

The massage band 3 comprises at least one row of massage heads 31 extending parallel to the perimeter of the helmet 2 and, more specifically, of the inner surface 2a. It preferably comprises a single row of massage heads 31 (FIG. 1) or two rows of mutually staggered heads 31.

The cranial stimulation device 1 comprises one or more massage blocks 4 fastened to the helmet 2 at the active surface.

The blocks 4 are, therefore, enclosed inside the massage band 3 and, therefore, the massage area 3a.

The device 1 preferably comprises several massage blocks 4 suitably equally spaced out.

Each massage block 4 comprises one or preferably more additional massage heads 41 defining an additional massage area 4a inside the helmet 2; and an additional handler 42 of said additional massage heads 41.

The additional massage area 4a may have any profile. It is preferably circular. Areas 3a 3 4a are preferably spaced out.

Each additional massage head 41 defines a contact surface (in direct or indirect contact, e.g. through the hair) with the scalp, said surface being preferably spherical. It may be of a known type.

An additional massage head 41 (FIG. 3) may comprise an additional contact portion 41a and preferably an additional support portion 41b located between the additional contact portion 41a and the additional handler 42.

The additional support portion 41b may define an additional longitudinal axis 41c suitable for placing in use substantially perpendicular to the scalp. During operation, it may be used to rotate the additional contact portion 41a around said additional longitudinal axis 41c.

The additional handler 42 is suitable for fastening the heads 31 to the helmet 2.

The additional handler 42 is electric.

It is suitable for moving the additional massage heads 41 by making them complete a suitably circular trajectory. More specifically, it is suitable for moving them synchronously and/or reciprocally.

The cranial stimulation device 1 comprises a control unit 5 suitable for controlling the motion of the massage band 3 and of one or more massage blocks 4 by varying their mutual distance.

In particular, the control unit 5 is suitable for controlling the motion of massage band 3 and of one or more massage blocks 4 by varying the mutual distance between a massage area 3a and at least one additional massage area 4a.

In addition, the control unit 5 may be used to control the motion of massage blocks 4 by varying the reciprocal distance between the additional massage areas 4a.

The cranial stimulation device 1 may comprise a power supply for the device itself and/or interface means suitable for allowing the user to control the device.

The power supply may comprise a battery and/or connector to an external power supply network.

The operation of the cranial stimulation device 1, previously described in structural terms, is as follows.

The cranial stimulation device 1 is worn by bringing the massage areas into contact with the scalp.

At this point the user, through the interface means, controls the control unit to activate the massage band 3 and the massage blocks 4 and, in particular, to move them by varying the distance between the massage area 3a and additional massage areas 4a and, preferably, between the additional massage areas 4a.

The cranial stimulation device 1 according to the invention entails important advantages.

In fact, the cranial stimulation device 1 by massaging the scalp allows the reactivation of cerebrospinal fluid circulation. At least, therefore, it alleviates symptoms resulting from poor cerebrospinal fluid circulation, such as fatigue, lack of mental concentration, lack of energy and hair loss.

We note that the particular movement of the massage areas 3a and 4a described above allows the maximising of the cranial stimulation device's 1 effectiveness and, therefore, of its positive effects on cerebrospinal fluid circulation.

Another advantage, therefore, derives from the fact that the device 1 stimulates hair regrowth.

The invention is susceptible of variations falling within the scope of the inventive concept as defined by the claims. Within the scope of the inventive concept, all details are replaceable by equivalent elements, and the materials, shapes and dimensions may be any type of materials, shapes and dimensions.

1. A cranial stimulation device comprising:
a helmet suitable for wrapping at least a portion of a user's head and defining an inner surface facing said head;
a massage band extending along the perimeter of said active surface;
at least one massage block fastened to said helmet at said active surface; and
a control unit suitable for controlling the motion of said massage band and of said massage block by varying the reciprocal distance between said massage band and said massage block.

2. The cranial stimulation device according to claim 1, comprising several massage blocks defining additional massage areas that are equally spaced out.

3. The cranial stimulation device according to claim 2, in which said control unit is suitable for controlling the motion of said massage blocks by varying the reciprocal distance between said additional massage areas.

4. The cranial stimulation device according to claim 1, in which said massage band comprises massage heads and a handler of said massage heads.

5. The cranial stimulation device according to claim 4, in which said each of said massage heads comprises a contact portion and a support portion of said contact portion; and wherein said support portion defines a longitudinal axis and is suitable for rotating said contact portion around said longitudinal axis.

6. The cranial stimulation device according to claim 1, in which said massage block comprises additional massage heads and an additional handler of said additional massage heads.

7. The cranial stimulation device according to claim 6, wherein each of said additional massage heads comprises an additional contact portion and an additional support portion of said additional contact portion; and wherein said additional support portion defines an additional longitudinal axis and is suitable for rotating said additional contact portion around said additional longitudinal axis.

8. The cranial stimulation device according to claim 2, in which said massage band comprises massage heads and a handler of said massage heads.

9. The cranial stimulation device according to claim 8, in which said each of said massage heads comprises a contact portion and a support portion of said contact portion; and wherein said support portion defines a longitudinal axis and is suitable for rotating said contact portion around said longitudinal axis.
